(19) United States
(12) Patent Application Publication
(10) Pub. No.: US 2017/0355471 A1
(43) Pub. Date: Dec. 14, 2017

(54) METHOD FOR JOINING SKIN PORTIONS OF A CIRCUMFERENTIALLY CLOSED FUSELAGE

(71) Applicant: Airbus Operations GmbH, Hamburg (DE)

(72) Inventor: Paul Joern, Hamburg (DE)

(73) Assignee: Airbus Operations GmbH, Hamburg (DE)

(21) Appl. No.: 15/613,558

(22) Filed: Jun. 5, 2017

(30) Foreign Application Priority Data
Jun. 8, 2016 (DE) 10 2016 210 089.0

(51) Int. Cl. B64F 5/10; B23K 20/12; B64D 11/06; B64C 1/20; B64C 1/12; B64C 1/06; B23K 101/00

(52) U.S. Cl. CPC B64F 5/10; B64C 1/12; B23K 20/122; B64C 1/064; B64D 11/0696; B64C 1/20; B23K 2201/006

(57) ABSTRACT

A method for joining skin portions of a closed fuselage, in particular for an aircraft or spacecraft, has the following method steps: providing at least a first skin portion and a second skin portion, at least one of the skin portions being fitted with components to remain in the fuselage; positioning at least the first skin portion and the second skin portion relative to one another in a first joint such that the skin portions form a circumferentially closed fuselage arrangement; guiding a first joining head along the first joint on an outer surface of the fuselage arrangement; and guiding a second joining head along the first joint on an inner surface of the fuselage arrangement, the second joining head being guided along longitudinal guide means which are arranged inside the circumferentially closed fuselage arrangement and are formed at least in part by the components to remain in the fuselage.

### FIELD OF THE INVENTION

The present invention relates to a method for joining skin portions of a circumferentially closed fuselage, in particular for an aircraft or spacecraft.

Although the present invention and the problem it addresses can be applied to any types of circumferentially closed fuselages, they will be described in detail with respect to the fuselage of an aircraft.

### BACKGROUND OF THE INVENTION

In aircraft fuselage production, riveting processes have mainly been used for a long time to join skin portions or fuselage sections. A riveting device for producing rivet joints is described in DE 198 34 702 A1. In this respect, a machine guidance system is provided which is arranged annularly outside around the fuselage of the aircraft and is movable in the longitudinal direction of the aircraft. In addition, an inner part of the riveting device is provided which has a holding frame which is movable in the longitudinal direction of the aircraft. The holding frame consists of a supporting arm stand, a supporting arm guidance and a supporting arm which is movable along the supporting arm guidance in the longitudinal direction of the aircraft.

In modern aircraft fuselages, welding processes are sometimes also used to join skin portions. In this respect, other specifically adapted methods and devices are used. For example, DE 10 2011 114 922 A1 describes a method in which positioning means in the form of a frame construction are attached to the outside of a fuselage. The positioning means are used to hold the fuselage portions which are to be joined together and at the same time as guide means for a friction stir welding head for joining the fuselage portions.

### BRIEF SUMMARY OF THE INVENTION

In view of the above, it is an idea of the present invention to provide an improved method for joining skin portions of a circumferentially closed fuselage.

Therefore the following is provided:
a method for joining skin portions of a circumferentially closed fuselage, in particular for an aircraft or spacecraft, having the following method steps: providing at least a first skin portion and a second skin portion, at least one of the provided skin portions being fitted with components provided to subsequently remain in the fuselage; positioning at least the first skin portion and the second skin portion relative to one another in a first joint so that the skin portions form a circumferentially closed fuselage arrangement; guiding a first joining head along the first joint on an outer surface of the fuselage arrangement and guiding a second joining head along the first joint on an inner surface of the fuselage arrangement, the second joining head being guided along longitudinal guide means which are arranged inside the circumferentially closed fuselage arrangement and are formed at least in part by the components provided to subsequently remain in the fuselage.
a joining device for joining skin portions of a circumferentially closed fuselage, comprising: a first joining head which can be guided along a joint on an outer surface of a circumferentially closed fuselage arrangement; a second joining head which can be guided along the joint on an inner surface of the circumferentially closed fuselage arrangement; and a substructure, said substructure being coupled to the second joining head and being configured to be guided along longitudinal guide means which are arranged inside the circumferentially closed fuselage arrangement and are formed at least in part by the components provided to subsequently remain in the fuselage.

One idea of the present invention is to attach components which are provided to subsequently remain in a fuselage to the skin portions before the skin portions are joined and to use these components as longitudinal guide means for a joining head for joining the skin portions.

The joining process is a process which is carried out on both sides of the skin of the fuselage. Thus, in addition to a joining head which is guided along a joint on the inside of the fuselage arrangement, a joining head is also guided along the joint on the outside of the fuselage arrangement. This makes it possible to produce a fuselage in a manner which is very dimensionally stable, yet simple and efficient. In particular, it is thus achieved that a skin portion which is pre-assembled with components provided to subsequently remain in the fuselage is joined relatively easily and synergistically using these components.

According to another embodiment, the skin portions contain a thermoplastic material, so that the joining process can involve a thermal joining process and/or a forming process. Alternatively or additionally, a different joining process can also be used.

A substructure which is guided on the longitudinal guide means can be provided as the connection of the second joining head to the longitudinal guide means.

To allow a flexible orientation of the second joining head, it is possible to provide a structure and/or a motor-driven adjusting means, in particular a multi-axis robot, between the substructure and the joining head.

The first and the second joining head can have very different configurations which are adapted to the chosen joining process. They are configured in particular to exert on the skin portions a joining force which is sufficient for joining the skin portions.

The circumferentially closed fuselage can be configured in many different ways. In particular, the fuselage is tube-shaped or barrel-shaped. However, other fuselage shapes are also conceivable, for example fuselage shapes which are oval or are formed with straight portions or with corners.

In particular, the fuselage according to the invention is a fuselage for an aircraft or spacecraft, for example for an airliner. Due to its dimensions, a fuselage of this type cannot be handled using conventional positioning means. Therefore, specific production facilities are required. The diameter of this type of fuselage amounts to in particular several metres. Correspondingly large skin portions are provided for positioning a circumferentially closed fuselage arrangement, for which purpose at least two skin portions in particular are required. Accordingly, an at least two-part fuselage arrangement is provided in particular. However, it is also possible to provide three-part, four-part or multi-part fuselage arrangements. Accordingly, a different number of the skin portions required for this purpose can also be provided for positioning the circumferentially closed fuselage arrangement.

The fuselage arrangement can be in particular only one fuselage portion or one fuselage section. However, it is also conceivable to thereby form an entire fuselage length. The fuselage arrangement is always circumferentially closed and one which in particular forms a complete closed fuselage cross section.

The fuselage arrangement can be configured to be open or closed at its longitudinal-side ends.

The components provided to subsequently remain in the fuselage can have very different configurations. They can be components which extend uniformly in the longitudinal direction of the fuselage.

The substructure of a joining device has a configuration which corresponds to the components provided to subsequently remain in the fuselage. In particular, the substructure is configured such that a longitudinal guidance of the second joining head is made possible in combination with the components provided to subsequently remain in the fuselage. For example, if an edge, running in the longitudinal direction, of a component is used for longitudinal guidance, the substructure can have a carriage which is formed corresponding to the edge. However, it is also conceivable that the components provided to subsequently remain in the fuselage form anchor points or orientation points which are provided to temporarily hold or fasten components of the substructure which extend in the longitudinal direction of the fuselage for guidance purposes.

In this way, the components provided to subsequently remain in the fuselage allow a longitudinal guidance of the substructure, so that the second joining head can be guided along the first joint.

Furthermore, the joining device can have a holding means for holding or fixing the skin portions and/or for movably mounting the first joining head which is to be guided along the first joint on the outer surface of the fuselage arrangement.

According to another development, the first joining head and the second joining head are provided as a welding head. It is also conceivable to provide only one of the two joining heads as a welding head. While being guided along the first joint, the welding head welds the first skin portion to the second skin portion. A single guidance of the welding head along the first joint can thereby be sufficient to join the first skin portion to the second skin portion. This allows a fuselage production which is very fast and very simple compared to riveting processes. Furthermore, as a result, the production time and also the production costs can be reduced. This embodiment can be used for skin portions which contain a metallic or thermoplastic material. In particular, this can be a fibre-reinforced plastics material with a thermoplastic matrix.

According to another embodiment, the first joining head and the second joining head are guided parallel to one another along the first joint in order to mutually support a joining force. In this way, the joining force does not need to be supported by the skin portions, so that the positioning of the skin portions can be maintained with a high degree of accuracy. Furthermore, in this way the skin portions are joined without a tension which is otherwise applied for example by a unilateral joining force. The joined connection is thus not influenced in respect of its form.

According to one embodiment, the second skin portion is positioned with a second joint. The second joint is either formed between the second skin portion and the first skin portion or between the second skin portion and a third skin portion. In this way, the skin portions are joined to form a fully circumferentially closed fuselage shape. The first case is for example a fuselage arrangement having two half-shells as skin portions. In particular in this respect, each of the two half-shells describes a curvature of 180°. In the second case, the fuselage arrangement can have a plurality of three or more skin portions. For example, an embodiment of a fuselage arrangement can have four skin portions, for example in the form of four quarter-shells. This allows a symmetrical arrangement. Further numbers of skin portions and other divisions are of course possible to form a circumferentially closed fuselage form.

According to one embodiment, a third joining head is guided along the second joint on an outer surface of the fuselage arrangement. Furthermore, a fourth joining head is guided along the second joint on an inner surface of the fuselage arrangement, the fourth joining head being guided along longitudinal guide means which are arranged inside the circumferentially closed fuselage arrangement. In this way production is possible within a relatively short time, since it is possible to work on or join the first joint and the second joint of the fuselage arrangement at the same time. In particular, the longitudinal guide means for guiding the fourth joining head can also be formed at least in part by the components provided to subsequently remain in the fuselage.

According to one embodiment, the third joining head and the fourth joining head are provided as a welding head. Alternatively, only one of the two joining heads, i.e. the third or the fourth joining head, can be provided as a welding head. While being guided along the second joint, the welding head welds the second skin portion to the first skin portion or to the third skin portion, depending on the number and division of skin portions in the circumferentially closed fuselage arrangement.

According to another embodiment, the third joining head and the fourth joining head are guided parallel to one another along the second joint in order to mutually support a joining force. As explained with regard to the first joint, this measure ensures that the joining force does not need to be supported by the skin portions. The joining procedure can thus be carried out in a state in which the skin portions are free of tension.

According to another embodiment, the first and the second joint are arranged on opposite sides of the fuselage arrangement. In this way, provided that a substructure is connected to hold the second and fourth joining heads together, it is possible for joining forces which act on the second and fourth welding heads to be compensated via the substructure. Thus, the longitudinal guide means provided inside the circumferentially closed fuselage arrangement do not need to support any great joining forces. In this way, components provided to subsequently remain in the fuselage can be used at least as part of the longitudinal guide means, because they remain intact due to the low effective forces.

According to a further embodiment, the third and the fourth joining heads are guided simultaneously parallel to the first and second joining heads. In particular, the two pairs of joining heads, i.e. the third and fourth joining head and also the first and second joining head, are guided directly opposite on the fuselage arrangement and optionally or additionally at the same height. Thus, the joining force can be applied symmetrically, so that an optimum support of the force is possible.

According to another embodiment, the second joining head and the fourth joining head are guided along common longitudinal guide means. Thus, effective forces from the second and fourth joining heads can be compensated, so that said forces do not have to be supported by the longitudinal guide means. In turn, this allows the use of components provided to subsequently remain in the fuselage as longitudinal guide means or as parts of the longitudinal guide means.

According to one embodiment, the components provided to subsequently remain in the fuselage are configured as an interior system. An interior system includes any type of installation which remains provided in the subsequent interior of a fuselage. This can be an interior system which undertakes structural tasks in the interior. It can be an interior system which extends at least in portions along the longitudinal axis of the fuselage, in particular an interior guide system or rail system. In this way, a system which is to be provided anyway in the fuselage can be used as longitudinal guide means for the second welding head and/or for the fourth welding head. In particular, the second welding head and/or the fourth welding head is provided for this purpose with a substructure which corresponds to the longitudinal guide means and is adapted to the interior system such that the longitudinal guidance of the second and/or fourth welding head is possible.

According to one embodiment, the interior system is configured as at least one seat rail which is anchored to the floor of a cabin. Thus, a rail system which is to be provided anyway in the fuselage can be used as longitudinal guide means for joining the skin portions.

According to a further embodiment, the interior system is configured as at least one cargo hold floor guide. For example, this can be a cargo hold floor rail. Alternatively or additionally, the cargo hold floor guide can also be for example guide means provided for freight containers. In addition, it is conceivable to configure the floor of the cargo hold with a continuous step in the longitudinal direction, and to guide the second and/or fourth welding head along this step, in particular by means of a substructure of the second and/or fourth welding head, which substructure is formed corresponding to the step and is configured for guidance along the step. In this way, the cargo hold or freight compartment which is provided anyway with longitudinal guide means can be used for guiding the welding head to join the skin portions.

According to a further embodiment, the components provided to subsequently remain in the fuselage are formed by at least one reinforced primary structural element which runs in the longitudinal direction of the fuselage. This can be in particular a reinforced stringer (known as a super stringer). The reinforced primary structural element is reinforced and/or enlarged and/or configured to project into an interior of the fuselage, in particular with respect to the other primary structural elements which run in the longitudinal direction of the fuselage. This configuration of the primary structural element can also be used for further functions in the subsequent fuselage, for example for the installation of particularly heavy components, for the installation of cabin modules or system modules or the like.

The above embodiments and developments may be combined with one another in any desired manner within reason. In particular, the features and elements described in respect of the method for joining skin portions are also features of a corresponding joining device provided for implementing the method and/or features of a corresponding arrangement for implementing the method.

Further possible embodiments, developments and implementations of the invention also include combinations, which have not been explicitly mentioned, of features of the invention described previously or in the following in relation to the embodiments. In particular, a person skilled in the art will also add individual aspects as improvements or as additions to the respective basic form of the present invention.

### BRIEF DESCRIPTION OF THE DRAWINGS

The invention is described in greater detail in the following by way of the accompanying drawings, in which:

FIG. 1 schematically shows the joining procedure of two skin portions of a circumferentially closed fuselage;

FIG. 2 is an arrangement for joining two skin portions of a circumferentially closed fuselage, shown schematically;

FIG. 3 is an arrangement for joining two skin portions of a circumferentially closed fuselage according to a further embodiment, shown schematically;

FIG. 4 is an arrangement for joining two skin portions of a circumferentially closed fuselage according to a further embodiment, shown schematically;

FIG. 5 is an arrangement for joining four skin portions of a circumferentially closed fuselage, shown schematically;

FIG. 6 is an embodiment of a further arrangement for joining skin portions of a fuselage, shown schematically; and

FIG. 7 shows an aircraft or spacecraft.

In the drawings, the same reference numerals denote identical or functionally identical components, unless indicated otherwise. The elements of the drawings are not necessarily shown true to scale relative to one another.

### DETAILED DESCRIPTION

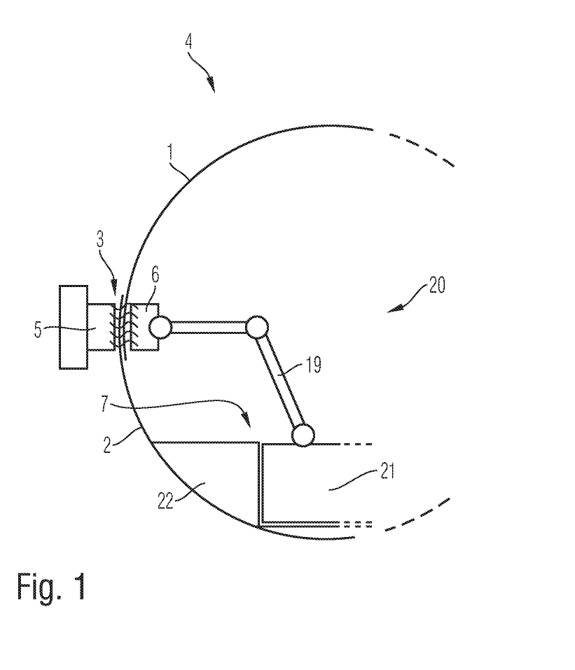

FIG. 1 schematically shows the joining procedure of two skin portions 1, 2 of a circumferentially closed fuselage.

Here, the fuselage to be produced by the joining procedure is shown schematically in cross section and only in portions. It is a circumferentially closed fuselage which is indicated by the lines continued in dashes.

The first and the second skin portions are positioned relative to one another in a first joint 3, so that the two skin portions 1, 2 describe a circumferentially closed fuselage arrangement 4, i.e. a complete fuselage cross section.

Here, purely by way of example, the first joint 3 forms a lap joint. However, a butt joint for example would also be conceivable. In this case, an additional connecting portion, for example a doubler, can be provided in the region of the joint 3.

Before the joining procedure, the second skin portion 2 has already been fitted with components 22 provided to subsequently remain in the fuselage to be produced. These components 22 form longitudinal guide means 7. A singular component or a plurality of components 22 can be provided and here, purely by way of example, a singular component 22, i.e. one component, is shown.

To join the two skin portions 1, 2, a first joining head 5 is guided along the first joint 3 on the outer surface of the fuselage arrangement 4. A second joining head 6 is guided along the first joint 3 on the inner surface of the fuselage arrangement 4. In this respect, this second joining head 6 is guided along the longitudinal guide means 7 formed by the components 22 inside the circumferentially closed fuselage arrangement 4.

To guide the second joining head 6 along the components 22 formed as longitudinal guide means 7, a substructure 21 is provided which is formed such that it corresponds to the components 22 and is coupled to the second welding head 6.

In the embodiment shown, the coupling comprises a motor-driven adjusting means 19 which is configured here purely by way of example as an articulated arm. Other configurations of a coupling of the substructure 21 to the second welding head 6, particularly also non-motor-driven couplings, are possible.

In the embodiment shown, the first joining head 5 and the second joining head 6 are guided simultaneously in parallel along the first joint 3 in order to join the first and second skin portions 1, 2, so that together they exert a joining action on the first joint 3, as indicated by the wavy lines in the region of the joint 3.

The joining heads 5, 6 can have very different configurations. For example, one of the joining heads 5, 6 or both joining heads 5, 6 can be a welding head. In this case, the skin portions 1, 2 are formed with a weldable material at least in the region of the joint 3. For example, a weldable material of one skin portion can contain thermoplastics. In particular, it can be a fibre composite material with a thermoplastic matrix.

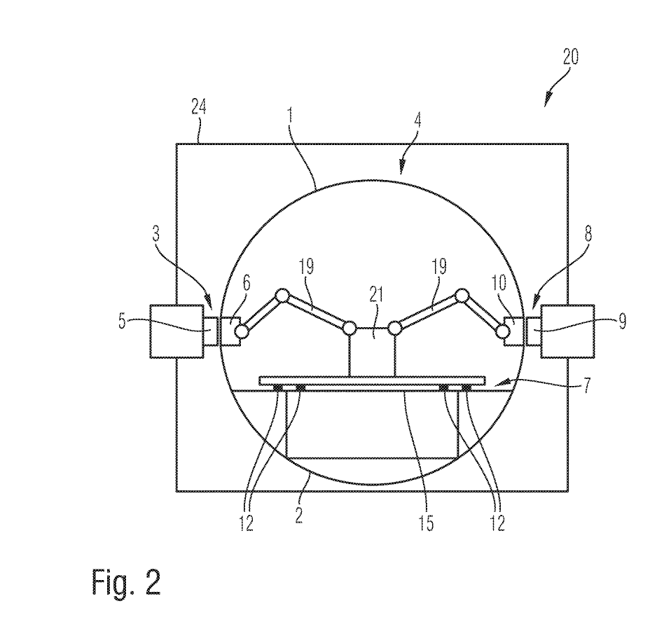

FIG. 2 schematically shows an arrangement for joining two skin portions 1, 2 of a circumferentially closed fuselage according to a further embodiment.

According to this embodiment, the second skin portion 2 is positioned with a second joint 8 between the second skin portion 2 and the first skin portion 1, in addition to the first joint 3. In this respect, the first and the second joint 3, 8 are arranged on opposite sides of the fuselage arrangement 4.

Here, the two skin portions 1, 2 are each configured as half-shells which each describe one half of a fuselage cross section and thereby form one half of the fuselage arrangement 4.

Before the skin portions 1, 2 are joined, they are fitted or preassembled with components, in particular with a cabin facing (not shown separately), a cabin floor 15 and also with other interior systems.

In the embodiment shown, the interior systems are pre-installed in the second skin portion 2 and are provided to subsequently remain in the finished fuselage.

Here, a joining device 20 provided for joining the first and the second skin portion 1, 2 has an outer holding means 24 in addition to the components shown in FIG. 1. The outer holding means is used, inter alia, for positioning the skin portions 1, 2.

Furthermore, in this embodiment, the joining device 20 has a third and a fourth joining head 9, 10. The third joining head 9 is guided along the second joint 8 on the outer surface of the fuselage arrangement 4. The fourth joining head 10 is guided along the second joint 8 on an inner surface of the fuselage arrangement 4. For this purpose, the fourth joining head 10 together with the second joining head 6 is guided along common longitudinal guide means 7 which are arranged inside the circumferentially closed fuselage arrangement 4.

Here, the longitudinal guide means 7 are configured as the seat rails 12 which are arranged in the cabin floor 15. A substructure 21 in the form of a gantry which runs in the seat rails is provided for guiding the second and fourth joining head 6, 10.

In the embodiment shown, the third and the fourth joining head 9, 10 are guided parallel to one another along the second joint 8. Furthermore, the third and the fourth joining head 9, 10 are also guided in parallel with and at the same height as the first and second joining head 5, 6.

This arrangement thereby mutually supports and thus compensates joining forces which act on the skin portions by the joining heads. Furthermore, joining forces from the second joining head 6 and the fourth joining head 10 which are to be supported are mutually supported by the motor-driven adjusting means 19 and by the substructure 21. No great lateral forces resulting from the joining forces thereby act on the seat rails 12. In this way, a longitudinal guidance of the welding heads 6, 10 is possible in the seat rails 12, without the seat rails 12 being damaged thereby.

In the embodiment shown, the holding means 24 is configured by way of example as a gantry which spans the fuselage arrangement 4. Here, in addition to the skin portions 1, 2, the holding means 24 also mounts the welding heads 5, 9 to be guided on the outer side of the fuselage arrangement 4. Therefore, in this case, the first and the third welding head 5, 9 are mounted such that they can be moved along the holding means 24 in the longitudinal direction of the fuselage, so that they can be guided along the first and second joint 3, 8 during the joining process.

A feed means (not shown here) can be provided for guiding the first and third welding head 5, 9 and/or for guiding the substructure 21 in the seat rails 12. This can be in particular a motor-driven and/or an automatic feed means. The feed of the first welding head 5, of the third welding head 9 and of the substructure 21 supporting the second and fourth welding heads can be coordinated.

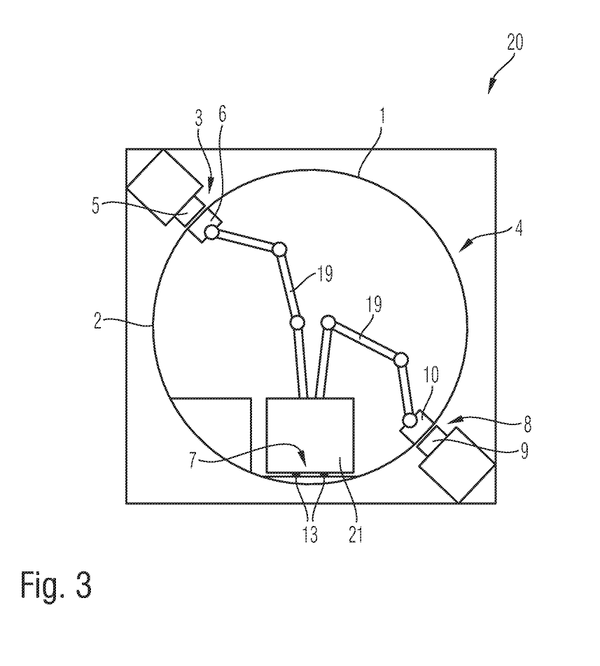

FIG. 3 schematically shows an arrangement for joining two skin portions 1, 2 of a circumferentially closed fuselage according to a further embodiment.

This embodiment differs from the embodiment according to FIG. 2 in that here the longitudinal guide means 7 are configured as cargo hold floor rails 13 in which the substructure 21 is guided. The cargo hold floor rails 13 are in particular guide rails and/or anchor rails which are arranged in a cargo hold and are provided in the subsequent cargo hold for guiding and/or anchoring cargo, in particular freight containers.

A further difference of this embodiment is that here the two joints 3, 8 do not lie in a common horizontal plane, but in a plane lying obliquely to the horizontal, though they are arranged directly opposite one another on the fuselage arrangement 4.

Accordingly, the motor-driven adjusting means 19, which can be configured here as a multi-axis industrial robot, are oriented at different angles to the horizontal.

The orientation, shown here, of the first and second joint 3, 8, can be an orientation which passes along the fuselage or also merely an orientation which is provided locally in the cross-sectional plane shown or is provided on an individual fuselage section.

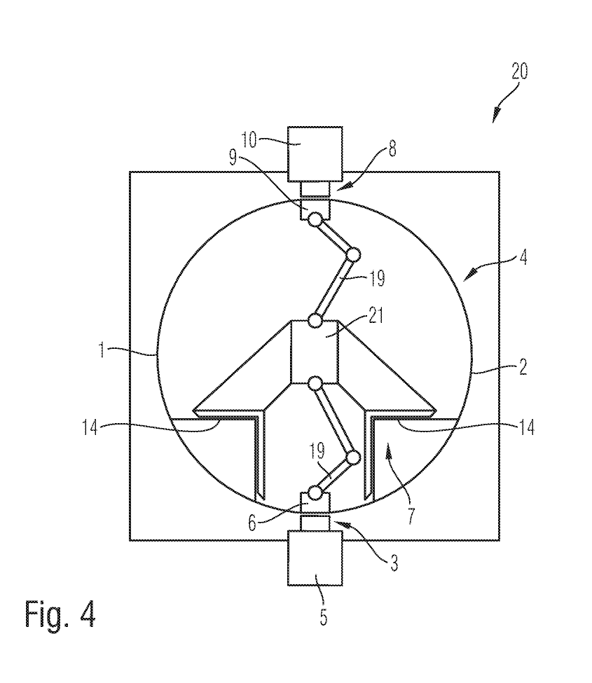

FIG. 4 schematically shows an arrangement for joining two skin portions 1, 2 of a circumferentially closed fuselage according to a further embodiment.

Unlike the embodiment according to FIGS. 2 and 3, here the longitudinal guide means 7 are configured as a cargo hold floor guidance provided inside a hold. In the embodiment shown, this cargo hold floor guidance is configured as lateral steps 14 which extend in the longitudinal direction of the fuselage. The steps 14 can be, for example, a delimitation of the hold. Furthermore, it would be possible for other interior components, for example a cabin floor, to be placed or mounted on the steps in a subsequent production stage.

Here, the substructure 21 has a correspondingly adapted form. Thus, provided here as the substructure 21 is a gantry which spans the hold and contacts the steps 14 on two sides in each case by an angle and which can thereby be guided securely along the steps 14.

A further difference in the embodiment shown here is that the first and the second joint 3, 8 are arranged opposite one another in a vertical plane. Thus, here a first motor-driven adjusting means 19 extends downwards from the substructure 21 into the region of the hold in which the first joint 3 is arranged. A second motor-driven adjusting means extends upwards from the substructure 21, in particular into the region of a cabin ceiling where the second joint 8 is arranged.

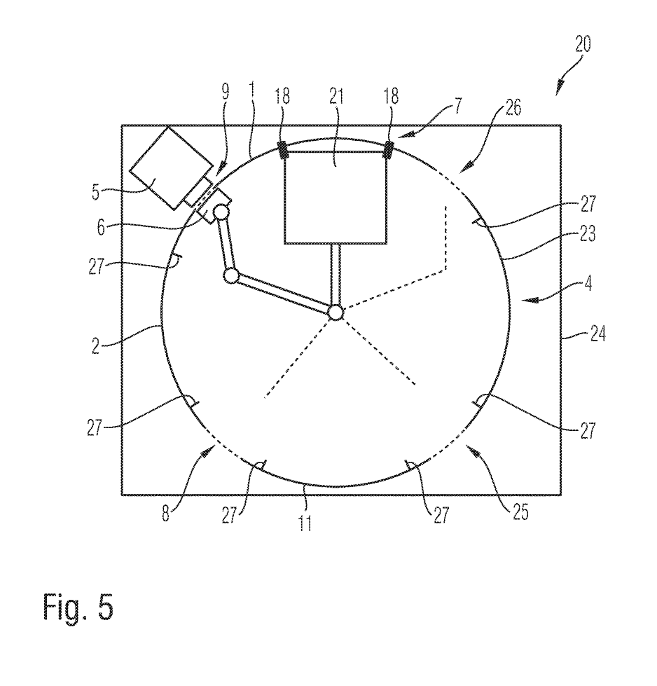

FIG. 5 schematically shows an arrangement for joining four skin portions of a circumferentially closed fuselage.

Unlike the previous embodiments, here the longitudinal guide means 7 are not formed by an interior system, but by reinforced primary structural elements 18 which extend in the longitudinal direction of the fuselage. The primary structural elements 18 are reinforced stringers which are configured to be significantly stronger than the other stringers 27 which are arranged on the fuselage.

In the embodiment shown, the substructure 21 is guided in a suspended manner from the reinforced primary structural elements 18 which extend in the longitudinal direction of the fuselage.

Furthermore, here unlike the previous embodiments, a total of four skin portions 1, 2, 11, 23 are positioned such that they form a circumferentially closed fuselage arrangement 4. For example, they are skin portions 1, 2, 11, 23 which are each configured as quarter shells.

The first joint 3 is provided between a first skin portion 1 and a second skin portion 2. A second joint 8 is provided between the second skin portion and a third skin portion 11. Furthermore, provided between the third skin portion 11 and a fourth skin portion 23 is a third joint 25 and provided between the fourth skin portion 23 and the first skin portion 1 is a fourth joint 26 which completes the circumferentially closed fuselage arrangement 4. The regions of the four joints 3, 8, 25, 26 are shown here in dotted lines merely to provide a clearer differentiation.

Yet another difference from the previous embodiments is that here only one pair of joining heads 5, 6 is provided, i.e. a first joining head 5 to be guided on the outer surface of the fuselage arrangement 4 and a second joining head 6 to be guided on the inner surface of the fuselage arrangement 4. In this respect, the second joining head 6 is coupled to the substructure 21 by a motor-driven adjusting means which is swivellable on all sides, for example in the form of a multi-axis, in particular a six-axis industrial robot.

The two welding heads 5, 6 are thus used here to join each of the four joints 3, 8, 25, 26. For example, the individual joints 3, 8, 25, 26 can be joined one after another. In order to join the four joints, a total of four working steps is thus necessary. Alternatively, the joints can also be joined consistently circumferentially at each of the joints in a longitudinal position so that the substructure is moved sequentially lengthwise when each of the joints 3, 8, 25, 26 has been joined locally in a longitudinal position.

With this arrangement, which has only one motor-driven adjusting means 19 and only one second welding head 6 on the substructure 21, the weight and size of the parts of the joining device 20 which run inside the circumferentially closed fuselage arrangement 4 can be reduced. In this way, the suspended configuration of the substructure 21 is more easily possible.

The first skin portion 1, on which the reinforced primary structural element 18 or the reinforced stringers extending in the longitudinal direction of the fuselage are provided, can be coupled in a particularly stable manner to the holding means 24 for holding the skin portion and to the part of the joining means 20 inside the fuselage.

After the joining procedure, the reinforced stringers can be used as super stringers, i.e. as multifunctional structural elements, for example for the installation of cabin or system modules.

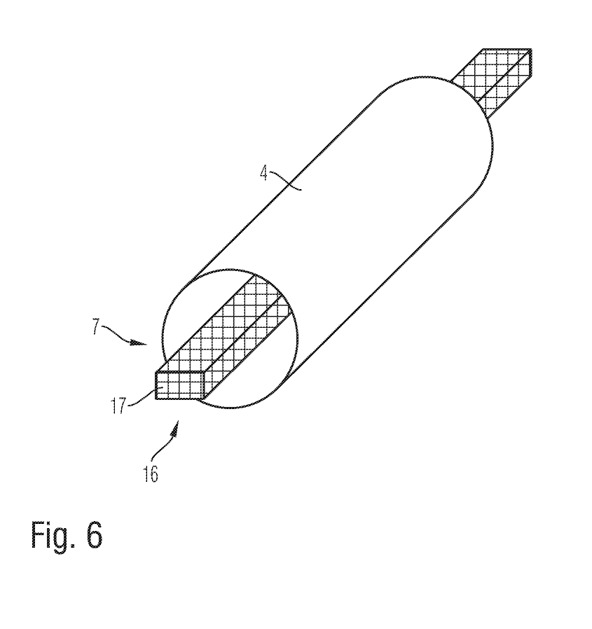

FIG. 6 schematically shows an embodiment of a further arrangement for joining skin portions of a fuselage.

For the sake of clarity, the individual skin portions 1, 2 and joining heads 5, 6 and 5, 6, 9 and 10 are not shown in this schematic drawing.

Optionally or in addition to the components 22 which are provided to subsequently remain in the fuselage, an externally introduced guide means 17 is introduced into the circumferentially closed fuselage arrangement 4 as part of the longitudinal guide means 7. After the joining procedure, said guide means can be removed for example though an open end 16 of the fuselage arrangement 4.

Here, it is possible to mount the guide means 17 on the components 22 provided to subsequently remain in the fuselage. Alternatively or additionally, an external mounting can be provided for the guide means 17.

The arrangement shown here is provided for a method for joining skin portions 1, 2; 1, 2, 11, 12 of a circumferentially closed fuselage, in particular for an aircraft or spacecraft, comprising the following method steps: providing at least a first skin portion 1 and a second skin portion 2; positioning at least the first skin portion 1 and the second skin portion 2 relative to one another in a first joint 3 such that the skin portions 1, 2; 1, 2, 11, 12 form a circumferentially closed fuselage arrangement 4; introducing a guide means 17 into the circumferentially closed fuselage arrangement 4; guiding a first joining head 5 along the first joint 3 on an outer surface of the fuselage arrangement 4; and guiding a second joining head 6 along the first joint 3 on an inner surface of the fuselage arrangement 4, the second joining head 6 being guided along longitudinal guide means 7 which are arranged inside the circumferentially closed fuselage arrangement 4 and are formed at least in part by the guide means 17.

In order to join the final joints, for example orbitally running joints on the nose of the fuselage, a further joining head can then be guided by a small flexible robot or a crawler inside the fuselage.

Alternatively or additionally, it is possible for other joints, for example the joint for integrating a structure surrounding a door of the fuselage, to be joined, in particular welded to one or more skin portions.

According to a further embodiment, the guide means 17 can firstly be constructed inside the circumferentially closed fuselage arrangement 4 and then dismantled again after the joining procedure. In this case, the guide means 17 is configured in a demountable and/or modular manner. For example, the guide means can be a demountable framework, formed with struts and couplings.

An arrangement of this type is then provided in particular for a method for joining skin portions 1, 2; 1, 2, 11, 12 of a circumferentially closed fuselage, in particular for an aircraft or spacecraft, comprising the following method steps: providing at least a first skin portion 1 and a second skin portion 2; positioning at least the first skin portion 1 and the second skin portion 2 relative to one another in a first joint 3 such that the skin portions 1, 2; 1, 2, 11, 12 form a circumferentially closed fuselage arrangement 4; constructing a guide means 17 inside the circumferentially closed fuselage arrangement 4; guiding a first joining head 5 along the first joint 3 on an outer surface of the fuselage arrangement 4; guiding a second joining head 6 along the first joint 3 on an inner surface of the fuselage arrangement 4, the second joining head 6 being guided along longitudinal guide means 7 which are arranged inside the circumferentially closed fuselage arrangement 4 and are formed at least in part by the guide means 17; and dismantling the guide means.

Of course, apart from the configuration of the longitudinal guide means 7, all the features of the previous embodiments can be combined with this arrangement according to FIG. 6 and with the arrangements and methods described in this connection.

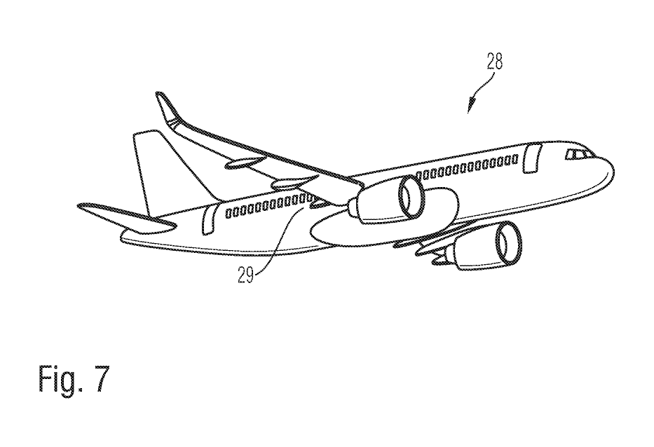

FIG. 7 shows an aircraft or spacecraft 28. In this case, it is for example an airliner. The aircraft or spacecraft 28 has a fuselage 29 which is produced according to any of the above-described methods for joining skin portions 1, 2 of a fuselage and with a corresponding joining device 20.

Although the present invention has been described here on the basis of several embodiments, it is not restricted thereto, but can be modified in many different ways.

For example, it is also conceivable that the welding heads, in particular the welding heads which are guided on the inner surface of the fuselage arrangement, are not guided parallel to one another along the joints. In this way, for example in the case of a limited amount of working space, it is possible to avoid a collision between the welding heads.

Furthermore, the longitudinal guide means 7 do not necessarily have to have symmetrically arranged guides. An individual guide, for example only one guide rail or guide structure can also be sufficient.

With each of the methods according to the invention, other types of joints of the skin portions can also be joined, in particular welded, for example in order to integrate a structure surrounding a door of the fuselage.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for joining skin portions of a circumferentially closed fuselage for an aircraft or spacecraft, the method comprising:
providing at least a first skin portion and a second skin portion, at least one of the provided skin portions being fitted with components provided to subsequently remain in the fuselage;
positioning at least the first skin portion and the second skin portion relative to one another in a first joint so that the skin portions form a circumferentially closed fuselage arrangement;
guiding a first joining head along the first joint on an outer surface of the fuselage arrangement; and
guiding a second joining head along the first joint on an inner surface of the fuselage arrangement, the second joining head being guided along longitudinal guide means which are arranged inside the circumferentially closed fuselage arrangement and are formed at least in part by the components provided to subsequently remain in the fuselage.

2. The method of claim 1, wherein at least one of the first joining head and the second joining head are provided as a welding head and, while being guided along the first joint, weld the first skin portion to the second skin portion.

3. The method of claim 1, wherein the first joining head and the second joining head are guided parallel to one another along the first joint to mutually support a joining force.

4. The method of claim 1, wherein the second skin portion is positioned with a second joint formed between the second skin portion and at least one of the first skin portion and a third skin portion.

5. The method of claim 4, wherein a third joining head is guided along the second joint on an outer surface of the fuselage arrangement and a fourth joining head is guided along the second joint on an inner surface of the fuselage arrangement, the fourth joining head being guided along longitudinal guide means arranged inside the circumferentially closed fuselage arrangement.

6. The method of claim 5, wherein at least one of the third joining head and the fourth joining head is provided as a welding head and, while being guided along the second joint, welds the second skin portion to at least one of the first skin portion and the third skin portion.

7. The method of claim 5, wherein the third joining head and the fourth joining head are guided parallel to one another along the second joint to mutually support a joining force.

8. The method of claim 5, wherein the first and the second joint are arranged on opposite sides of the fuselage arrangement.

9. The method of claim 5, wherein the third and fourth joining head are guided simultaneously parallel to the first and second joining head on the fuselage arrangement.

10. The method of claim 5, wherein the third and fourth joining head are guided simultaneously parallel to the first and second joining head directly opposite.

11. The method of claim 5, wherein the third and fourth joining head are guided simultaneously parallel to the first and second joining head at the same height.

12. The method of claim 5, wherein the second joining head and the fourth joining head are guided along common longitudinal guide means.

13. The method of claim 1, wherein the components provided to subsequently remain in the fuselage are configured as an interior system.

14. The method of claim 13, wherein the interior system is configured as at least one seat rail anchored to a cabin floor.

15. The method of claim 13, wherein the interior system is configured as at least one cargo hold floor guidance.

16. The method of claim 15, wherein the interior system is configured as a cargo hold floor rail.

17. The method of claim 1, wherein the components provided to subsequently remain in the fuselage are formed by at least one reinforced primary structural element, which runs in the longitudinal direction of the fuselage and is at least one of reinforced and enlarged.

18. The method of claim 17, wherein the components provided to subsequently remain in the fuselage are formed by a reinforced stringer.

19. The method of claim 17, wherein the components provided to subsequently remain in the fuselage are configured to project into an interior of the fuselage with respect to the other primary structural elements running in the longitudinal direction of the fuselage.

20. A joining device, comprising:
a first joining head configured to be guided along a joint on an outer surface of a circumferentially closed fuselage arrangement;
a second joining head configured to be guided along the joint on an inner surface of the circumferentially closed fuselage arrangement; and
a substructure, said substructure being coupled to the second joining head and being configured to be guided along longitudinal guide means arranged inside the circumferentially closed fuselage arrangement and formed at least in part by the components provided to subsequently remain in the fuselage.
